(19) United States
(12) Patent Application Publication
(10) Pub. No.: US 2006/0286529 A1
(43) Pub. Date: Dec. 21, 2006

(54) System and method for instruction of basic concepts

(76) Inventors: M. Thomas Webber JR., Greer, SC (US); Elisabeth H. Wiig, Arlington, TX (US)

Correspondence Address: MCNAIR LAW FIRM, P.A., P.O. BOX 10827, GREENVILLE, SC, 29603-0827, US

(21) Appl. No.: 11/154,848

(22) Filed: Jun. 16, 2005

(51) Int. Cl. G09B 3/00

(52) U.S. Cl. 434/322

(57) ABSTRACT

This invention is a system and method for assisting a teacher in the evaluation of basic concepts to a student. An illustration sheet having a set of illustrations representing a basic concept category is shown to the student. The teacher elicits receptive and expressive responses according to an activity sheet having receptive and expressive instructions. The determination of whether the student's response is correct according to a set of correct responses can be recorded on the activity sheet or a recording sheet.

### CROSS REFERENCE TO RELATED APPLICATION

This application claims priority from U.S. application Ser. No. 11/041,546, filed Jan. 24, 2005, entitled System and Method For Assessment of Basic Concepts.

### FIELD OF THE INVENTION

This invention relates to a system and method for the instruction of basic concepts. Specifically, the invention relates to the use of illustrations to receptively and expressively instruct basic concepts.

### BACKGROUND OF THE INVENTION

In the education of children, one of the fundamental skills that a child should develop is a solid understanding of “basic concepts.” Basic concepts are the building blocks that children use to follow directions, engage in classroom routines, and provide descriptions of the world around them. Basic concepts are instrumental in performing tasks such as reading, writing, speaking, and arithmetic. Basic concepts are integrated in nearly every aspect of classroom subjects so that the better a child understands basic concepts, the more a child will benefit from the educational process. The better the understanding of basic concepts, the more advanced the academic achievement of the child will be.

Basic concepts, which include colors, numbers, location words, and descriptive words are the building blocks that children need to communicate, follow directions, engage in classroom routines, and provide descriptions of everyday items. For example, children should be able to understand and differentiate verbally the size of an object as being big or small. Children should also be able to understand and differentiate the location of an object such as inside or outside. Understanding these concepts is fundamental so that children can perform everyday tasks such as listening, speaking, reading, writing, and arithmetic.

Generally, basic concepts can be divided into basic concept categories. These basic concept categories include: color/shape; weight/forms; distance/speed/time; quantity/completeness; location/direction/condition/quality; sensation/emotion/valuation. For example, category of color/shape may include testing of the child's ability to distinguish between square and round, blue and red, green and yellow, and orange and brown. For a further example of basic concepts, see patent application Ser. No. 11/041,546 which discloses a System and Method for Assessing Basic Concepts, receptively and expressively.

Receptive testing of basic concepts involves pointing and other non-verbal responses to questions or prompts asked during testing. Expressive testing of basic concepts involves verbal responses to questions or prompts asked during testing. As this system and method for assessing basic concepts is novel, no system and method for instructing basic concepts in this manner has been developed. As parents often desire their children to be as prepared as possible for any assessment, it would be advantageous to have a system and method that prepares a student for an assessment of basic concepts, both expressively and receptively.

Therefore, a system and method for instructing basic concepts to a child is needed using both receptive and expressive activities.

### SUMMARY OF THE INVENTION

The invention is a system for assisting in the instruction of basic concepts to an individual. The invention consists of an illustration sheet associated with a basic concept category and sets of receptive and expressive activities associated with the illustration sheet for eliciting receptive and expressive responses from the individual. Further, a set of correct expressive responses is included for comparison with the expressive response given by the individual according to the expressive activity. In this manner, an individual is instructed basic concepts expressively and receptively with multiple activities associated with at least one illustration.

The system includes an activity sheet corresponding to the illustration sheet which includes the sets of receptive activities, expressive activities and correct expressive responses. The illustration sheet may contain a plurality of concepts that are at least one related pair. The illustration sheet may contain three illustrations corresponding to the basic concept wherein two of the three illustrations associated with the concept form a related pair. The remaining illustration associated with the concept represents a foil in between the related pair. A record form is included in the system for recording the receptive and expressive progress of an individual being instructed.

The invention incorporates a method for assisting in the instruction of basic concepts to an individual by the use of an illustration sheet. In order to elicit receptive or expressive responses from the individual, the individual is presented with receptive and expressive activities based on the illustration sheet Further, the expressive response of the individual is compared to a predetermined correct expressive response in order to determine if the individual has answered correctly. In this manner, an individual is instructed basic concepts receptively and expressively with a plurality of receptive and expressive activities associated with the illustration sheet.

### DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is an illustration of the invention is use;

FIG. 2 is a top plan view of an example illustration page according to the invention;

FIG. 3 is a top plan view of an example sheet containing receptive and expressive activities;

FIG. 4a is a top plan view of an example illustration sheet according to the invention; and

FIG. 4b is a top plan view of an example illustration sheet according to the invention.

### DESCRIPTION OF A PREFERRED EMBODIMENT

Referring now in more detail to the drawings, the invention will be described in more detail.

This invention is a system and method for instruction of basic concepts. The system uses a variety of illustration sheets to present multiple illustrations used to assess a variety of basic concepts. An illustration sheet may comprise a piece of paper having an illustration, a card stock game board having an illustration, or any other means of presenting illustrations to a student. The illustrations may be presented in color or black and white. Note that color illustrations have been found to be more stimulating for children than black and white illustrations. Each illustration sheet can be arranged so as to depict a scene. More importantly, each illustration depicts basic concepts to be assessed. For example, the illustrations may include a bear inside a cave and a bear outside of a cave. This allows the teacher to teach the concept inside and outside. Further, the illustration sheets are designed to instruct receptively and expressively. The receptive response occurs first with the student pointing to the bear that is inside in response to a cue by the teacher. The expressive response comes when the teacher points to the bear outside and asks the student where the bear is. If the student replies “outside” his/her response is correct and thus, understands the concept.

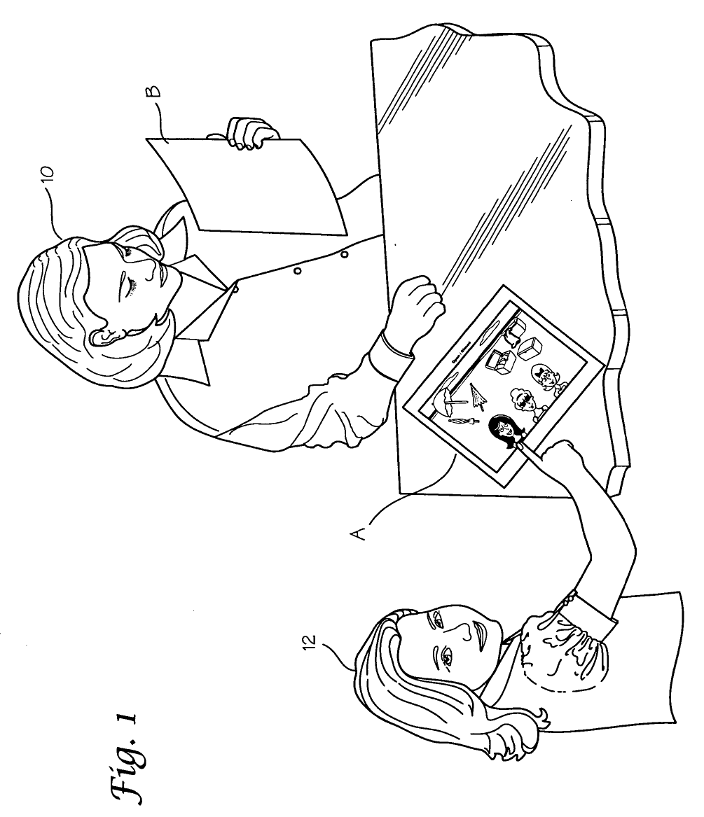

Referring now to FIG. 1, the invention is described in more detail. As can be seen in FIG. 1, teacher 10 is instructing student 12 basic concepts according to the invention. Illustration sheet A is shown to the child to allow the child to assist in teaching the child basic concepts. Teacher 10 has activity sheet B which contains a set of receptive activities associated with the illustration sheet. These receptive activities may include questions and are designed to elicit a receptive response from the student. Receptive responses, as discussed above, deal with pointing responses or other non-verbal responses. A set of expressive activities 22 are also included on activity sheet B. Each expressive activity contains a corresponding correct expressive response for comparison with the expressive response given by the student. The set of expressive activities are associated with an illustration and designed to elicit an expressive response from the individual.

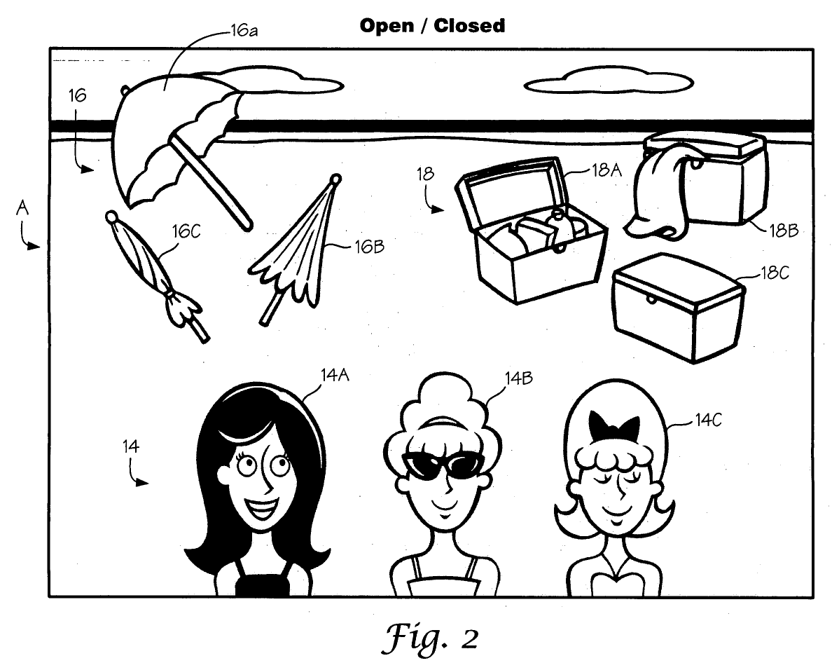

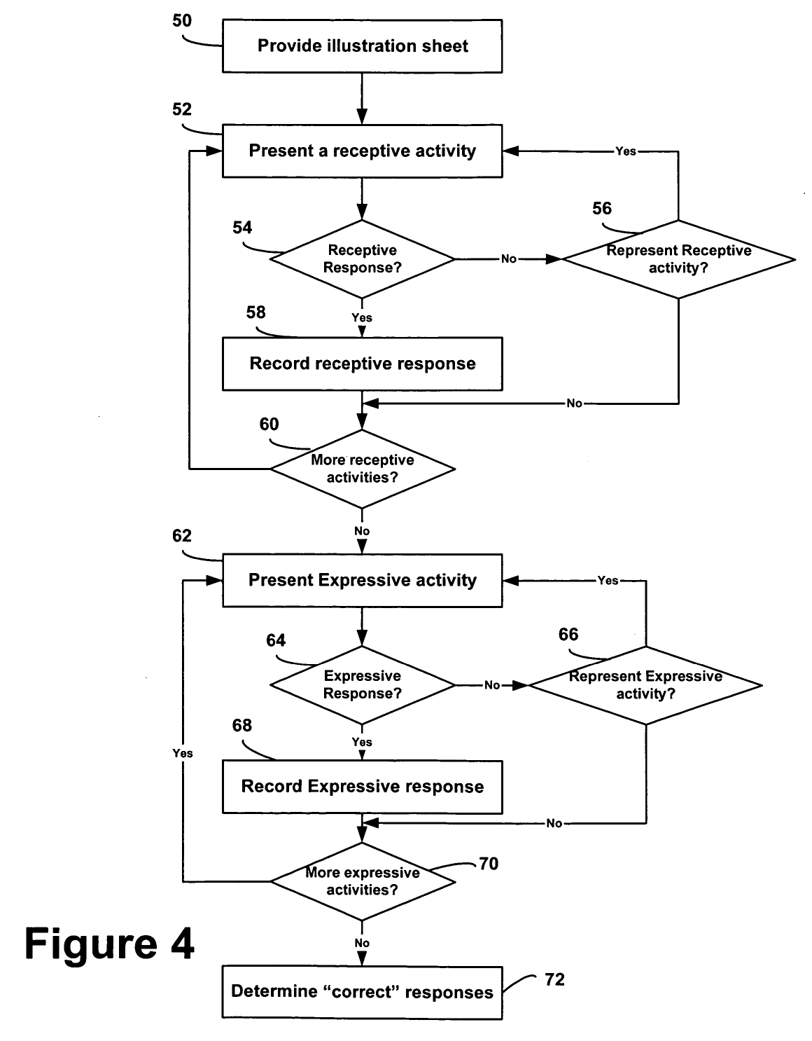

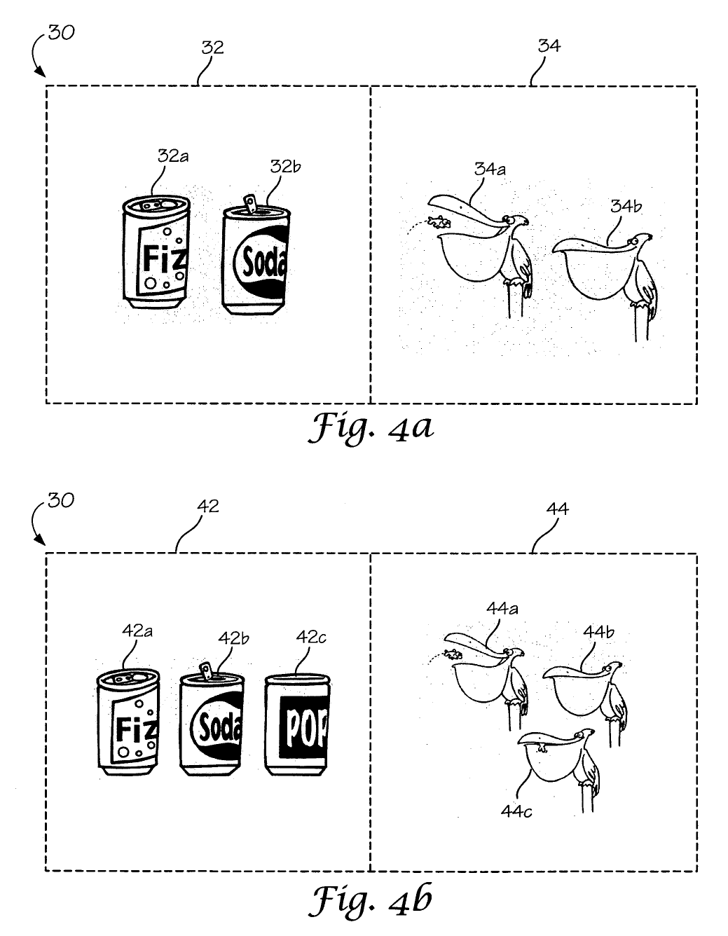

Each illustration sheet may show two or three pictured choices. Teachers may three levels of illustration sheets. The first level used in instruction shows the basic concept in a related pair. This is best illustrated in FIG. 4a, which covers the basic concept of open and closed. In FIG. 4a, can 32a shows the closed position and can 32b shows the open position. Thus, teachers may teach the basic concept of open and closed using a related pair as illustrated in FIG. 4a. The second level of illustration sheets teaches the concept using related pairs and a foil. FIG. 4b best illustrates this type of illustration sheet. In FIG. 4b, can 42a is closed, can 42b is open, and can 42c is neither open nor closed and serves as a foil. The third level of illustration sheets involve illustrating a basic concept in a pair along with a foil on a scene. Illustration sheet a on FIG. 2 shows this level of illustration sheet. One of the pictures, such as shown as 14a of FIG. 2, can be used as a receptive target. If the teacher asks the student to point to figure whose eyes are open, illustration 14a is the receptive target since the student is asked to “point” to the figure with open eyes. If the teacher asks the student to tell the teacher which figure has open eyes, illustration 14a is the expressive target since the student is asked to respond, “the lady on the left.” Illustration 14b depicts a concept “in between” illustration 14a and 14c and acts as a foil since the sunglasses hide the eyes. The stimulus items used to elicit the receptive (pointing) and expressive (describing) responses are printed on the corresponding record forms. The opposite or related word pairs depicted in each scene elicit a receptive and an expressive response based on certain features in each illustration.

As can best be seen in FIG. 2, illustration sheet A contains three sets of illustrations. Each of these three sets of illustrations deal with the basic concept of open/closed. Set 14 contains illustrations 14a showing an individual with open eyes, 14b an individual wearing sunglasses, and 14c an individual with closed eyes. As described above, illustrations 14a and 14c can be used for receptive or expressive activities and may be correct responses to those activities. Illustration 14b is a foil which depicts a concept in between open and closed. As the student cannot see the eyes of the person shown as 14b, the student should not be able to answer whether the eyes of the person indicated as 14b are open or closed. Likewise, set 16 contains three illustrations of an umbrella. Umbrella 16a is clearly open, while umbrella 16c is clearly closed. Umbrella 16b acts as a foil as it is neither completely open nor completely closed. Similarly, set 18 depicts three coolers. Cooler 18a is clearly open and cooler 18c is clearly closed. Cooler 18b acts as the foil as it is neither completely open nor completely closed.

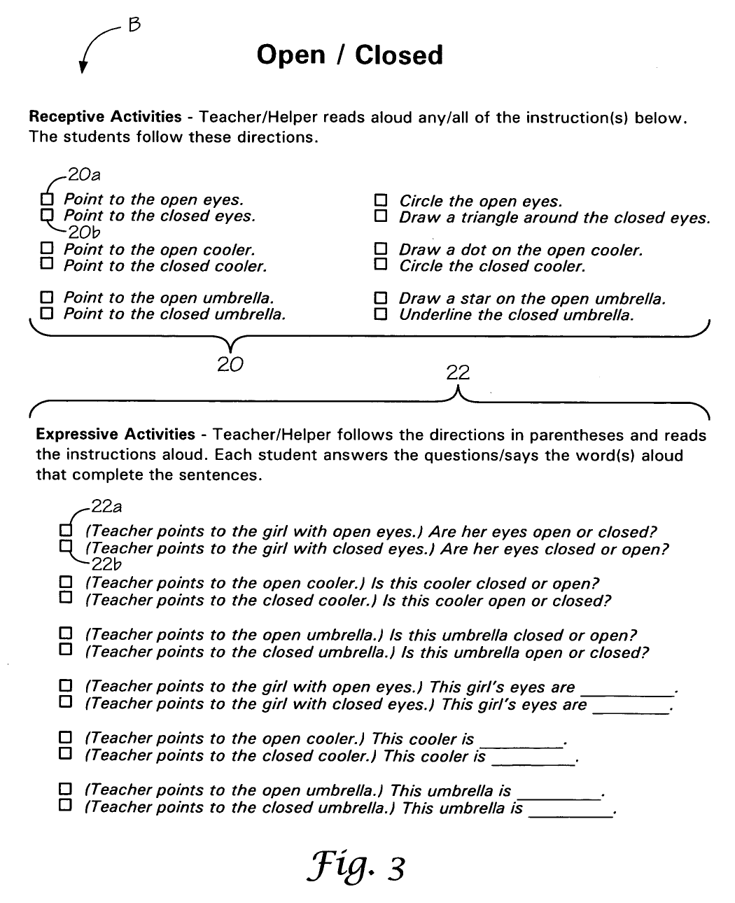

Activity sheet B is shown in more detail in FIG. 3. A set of receptive activities 20 contains activities designed to elicit receptive responses from the student. For example, they include receptive activities 20a and 20b. These receptive activities are associated with the set of illustrations 14 on illustration sheet A. These receptive activities ask the student to point to the open eyes 20a. The receptive activity 20b asks the student to point to the closed eyes. Multiple other pointing receptive activities are illustrated in FIG. 3. Various other receptive activities including circling open eyes, drawing triangles around closed eyes, drawing stars on open umbrellas, and underlining the closed umbrella are also included in the receptive activities. As discussed above, the receptive activities are designed to assist in the instruction of basic concepts. The teacher will also expressively instruct the basic concepts, open and closed, according to activity sheet B. A set of expressive activities 22 is also included on activity sheet B. Expressive activity 22a instructs the teacher to point to the girl with the open eyes and asks the expressive activity “are her eyes open or closed,” thus completing the expressive activity. The teacher has the correct expressive response in the preamble to the expressive activity. Thus, the teacher is able to determine instantaneously if the student has correctly completed the expressive activity. As such, the students may be instructed basic concepts, receptively and expressively.

In one embodiment, the illustration sheet can have a front side and a back side. The front side can contain the set of illustrations associated with a basic concept category and the back side can contain the activity sheet. Further, a recording sheet can also be used to record whether receptive or expressive responses from the student are correct. The determination as to whether the receptive or expressive responses are correct can also be recorded on the activity sheet.

Teacher 10 is instructing the basic concept open/closed in the figures. First, teacher 10 reads the receptive activity for eliciting a pointing (receptive) response (“point to the open eyes”). When inquiring of the student, the response can be timed. In one embodiment, Teacher waits between 5 to 10 seconds for the student to respond. If the student does not respond, the question can be repeated. If the student does not respond after an additional 5 to 10 seconds, the teacher should not continue with the corresponding expressive stimulus item. If the student points (receptive) to the wrong response (a foil or prop), teacher 10 may choose whether or not to correct the child. If child 12 responds correctly to the receptive activity, teacher 10 should read the expressive activity and wait 5 to 10 seconds for student to verbally respond. If student 12 does not verbally respond, teacher 10 may repeat the expressive activity and wait another 5 seconds. If the student produces an incorrect response, teacher 10 should choose whether or not to correct the student. Teacher 10 should go to the next receptive item and say, for example, “Here is another picture,” or “Let's move on.” Teacher 10 should repeat this procedure as many times as Teacher 10 determines necessary to instruct the basic concepts.

For example, FIG. 2 shows an illustration sheet used in the instruction, shown generally as A. It depicts three women, one with open eyes 14a, one with sunglasses 14b, and one with closed eyes 14c. Teacher 10 asks the student a receptive activity that is used to elicit the receptive, pointing response for “open.” As shown on activity sheet B in FIG. 3, the teacher asks the student to, “Point to the open eyes.” As shown in FIG. 1, the student correctly identifies illustration 14a. The student may then be shown the girl with her eyes closed to elicit the expressive, naming response “closed . ” Again, as shown in FIG. 3, the teacher reads expressive activity 22b. [Teacher points to the girl with closed eyes] “Are her eyes open or closed?” and the child says, [correctly] “closed”).

For some test items, the least preferred concept in a word pair is used to elicit a pointing response, while the preferred concept is used to elicit a naming response. The least preferred concept of a word pair is also often the concept that the student develops later in the learning process. The preferred concept is often developed earlier in the student's development. Note that the illustration described above does not use a pair in this manner. For example, the usually least preferred concept word “outside” may be used to elicit a receptive response, while the usually preferred concept word “inside” is used to elicit an expressive response. As an example, some children may prefer “big” toys (cars, dolls) early on, but change their preference to “small” toys (miniature dolls, cars) as they get older. The receptive and expressive responses are elicited in relation to certain characteristics of people, animals, or objects featured in each scene.

As can best be seen in FIG. 4, an embodiment of the method for instructing basic concepts according to the invention is shown. Initially, an illustration sheet should be provided to the student at step 50. As discussed above, the illustration sheet presents illustrations depicting a basic concept. The teacher should then present a receptive activity to the student at step 52. If the student gives a receptive response at step 54, then the receptive response should be recorded at step 58. If the student fails to give a receptive response at step 54, than the teacher may choose to represent the receptive activity at step 56. If the teacher chooses not to represent the receptive activity or after a given receptive response has been recorded, then the teacher determines if more receptive activities are needed at step 60. If so, the teacher returns to step 52 and presents a receptive activity. If not, the teacher presents an expressive activity based on the same illustration sheet at step 62. If the student gives an expressive response at step 64, then the expressive response should be recorded at step 68. If the student fails to give an expressive response at step 64, than the teacher may choose to represent the expressive activity at step 66. If the teacher chooses not to represent the expressive activity or after a given expressive response has been recorded, then the teacher then determines if more expressive activities are needed at step 60. If so, the teacher returns to step 62 and presents an expressive activity. If not, then the teacher may determine how many “correct” responses were given at step 72.

While a preferred embodiment of the invention has been described using specific terms, such description is for illustrative purposes only, and it is to be understood that changes and variations may be made without departing from the spirit or scope of the following claims.

What is claimed is:

1. A system for assisting a teacher in providing the education of basic concepts to a student comprising:
an illustration sheet;
a set of illustrations contained on said illustration sheet representing a basic concept category;
an activity sheet associated with said illustration sheet;
a receptive activity instruction contained on said activity sheet for providing the teacher with instruction for how to elicit a receptive response from the student according to said set of illustrations;
an expressive activity instruction contained on said activity sheet for providing the teacher with instruction for how to elicit an expressive response from the student according to said set of illustrations so that the teacher is assisted in providing education to the student for basic concepts using both receptive and expressive skills.

2. The system of claim 1 including a set of correct receptive responses associated with said set of illustrations for comparison with the receptive responses received from the student.

3. The system of claim 1 including a set of correct expressive responses associated with said set of illustrations for comparison with the expressive responses received from the student.

4. The system of claim 1 including response recording areas contained on said activity sheet for recording receptive and expressive responses from the student.

5. The system of claim 1 including a foil illustration associated with said set of illustrations.

6. The system of claim 1 including a recording sheet associated with said set of illustrations for recording receptive and expressive responses from the student.

7. The system of claim 1 including a plurality of illustration sheets, said each illustration sheet is associated with a basic concept category.

8. A system for assisting a teacher in providing the education of basic concepts to a student comprising:
an illustration sheet having a front side and a back side;
a set of illustrations contained on said front side of said illustration sheet representing a basic concept category;
a receptive activity instruction contained on said back side of said illustration sheet for providing the teacher with instruction for how to elicit a receptive response from the student according to said set of illustrations; and,
an expressive activity instruction contained on said back side of said illustration sheet for providing the teacher with instruction for how to elicit an expressive response from the student according to said set of illustrations.

9. The system of claim 8 having response recording areas contained on said back side of said illustration sheet for recording receptive and expressive responses from the student.

10. The system of claim 8 including a foil illustration associated with said set of illustrations.

11. The system of claim 8 including a recording sheet associated with said set of illustrations for recording receptive and expressive responses from the student.

12. The system of claim 8 including a plurality of illustration sheets, said each illustration sheet is associated with a basic concept category.

13. A method for assisting a teacher in providing the education of basic concepts to a student comprising the steps of:
providing a set of illustrations representing a basic concept category to the student;
attempting to elicit a receptive response from the student according to said set of illustrations and a receptive inquiry from the teacher;
attempting to elicit an expressive response from the student according to said set of illustrations and an expressive inquiry from the teacher; whereby
a student is instructed basic concepts using a set of illustrations and receptive and expressive inquiries.

14. The method of claim 13 including the step of determining whether to attempt to elicit a further receptive response with a further receptive inquiry based on the students understanding of the basic concept.

15. The method of claim 13 including the step of determining whether to attempt to elicit a further expressive response with a further expressive inquiry based on the students understanding of the basic concept.

16. The method of claim 13 including the step of:
comparing a receptive response from the student with a correct receptive response; and
recording whether said receptive response from the student is correct.

17. The method of claim 16 wherein said step of recording whether said receptive response from the student is correct includes the step of recording whether said receptive response is correct on an activity sheet.

18. The method of claim 13 including the step of:
comparing an expressive response from the student with a correct expressive response; and
recording whether said expressive response from the student is correct.

19. The method of claim 18 wherein said step of recording whether said expressive response from the student is correct includes the step of recording whether said expressive response is correct on an activity sheet.

20. The method of claim 13 wherein said step of providing a set of illustrations includes the step of providing a set of illustrations having a foil illustration associated with said set of illustrations.

21. The method of claim 13 including the step of providing an activity sheet having a receptive instruction for the teacher to instruct the teacher how to make a receptive inquiry and an expressive instruction to instruct the teacher how to make an expressive inquiry.
